(19) United States
(12) Patent Application Publication
(10) Pub. No.: US 2023/0182373 A1
(43) Pub. Date: Jun. 15, 2023

(54) PROTECTOR STICKING ASSIST DEVICE FOR ELECTRONIC EQUIPMENT

(71) Applicant: Yongjun Tang, Zhuhai (CN)

(72) Inventor: Yongjun Tang, Zhuhai (CN)

(21) Appl. No.: 18/105,263

(22) Filed: Feb. 3, 2023

(30) Foreign Application Priority Data
Jul. 20, 2022 (JP) 2022-002383

(51) Int. Cl. B29C 63/00

(52) U.S. Cl. CPC B29C 63/0004; B29C 63/0017; B29C 2063/0008; B29L 2031/3437

(57) ABSTRACT

The present disclosure provides a protector sticking assist device for electronic equipment, including a protector sticking assist device main body, an electronic equipment containing slot is formed at a position where the protector sticking assist device main body corresponds to the electronic equipment, a tempered glass screen protector containing slot is formed in a slot bottom of the electronic equipment containing slot, an interval top resisting portion is disposed between an inner side of a slot wall of the electronic equipment containing slot and a top of a slot wall of the tempered glass screen protector containing slot, and a screen protector traction paste threading slot is formed in a slot wall of a lower end of the electronic equipment containing slot.

### TECHNICAL FIELD

The present disclosure belongs to the technical field of protector sticking for electronic equipment, in particular to a protector sticking assist device for electronic equipment.

### BACKGROUND

With the improvement of living standards, people also have higher and higher using frequency for portable electronic equipment, such as mobile phones, tablet computers, etc. For protecting the screen of the electronic equipment, users will usually paste a layer of tempered glass screen protector on a surface of a display screen so as to enhance screen protection.

In order to protect the tempered glass screen protector from being damaged, the tempered glass screen protector sold on the market usually includes a tempered glass screen protector main body, and the front and the rear of the tempered glass screen protector will be all pasted with a release layer screen protector. During protector sticking, the screen protector at the back is torn first, and then the tempered glass screen protector main body is pasted on the electronic equipment; and after air between the tempered glass screen protector main body and a screen is squeezed out, the screen protector at the front of the tempered glass screen protector main body is torn, namely, the protector sticking work is finished.

However, the screen protector at the back of the tempered glass screen protector main body needs to be torn manually before sticking the protector, and then the tempered glass screen protector main body is placed in the protector sticking assist device for the electronic equipment for sticking the protector. During a manual operation process, a sticking surface of the tempered glass screen protector is easy to absorb dust in the air or taint with fingerprint of a user during an operation process, so that the tempered glass screen protector main body cannot be used normally due to being tainted with flaws, thereby affecting the using experience of the user.

### SUMMARY

The main purpose of the present disclosure is to provide a protector sticking assist device for electronic equipment, including a protector sticking assist device main body, an electronic equipment containing slot is formed in the protector sticking assist device main body, a tempered glass screen protector containing slot is formed in a slot bottom of the electronic equipment containing slot, an interval top resisting portion is disposed between an inner side of a slot wall of the electronic equipment containing slot and a top of a slot wall of the tempered glass screen protector containing slot, and a screen protector traction paste threading slot is formed in a slot wall of a lower end of the electronic equipment containing slot; and when the electronic equipment is contained in the electronic equipment containing slot, the electronic equipment resists to the interval top resisting portion, so that a certain distance is spaced between the electronic equipment and the tempered glass screen protector containing slot, and the electronic equipment screen protector traction paste passes through the screen protector traction paste threading slot so as to tear the screen protector at the back of the tempered glass screen protector. After adopting the above solution, the tempered glass screen protector with the screen protector is placed into the tempered glass screen protector containing slot first during a using process, the electronic equipment is placed into a hand containing slot, the user pulls out the screen protector traction paste from the position of the screen protector traction paste threading slot, and then the screen protector at the back of the tempered glass screen protector is torn. Before sticking the protector, the screen protector at the back of the tempered glass screen protector main body does not need to be torn manually, and a defect that a sticking surface of the tempered glass screen protector is easy to absorb dust in the air during the manual operation process or taint with fingerprint of the user during the operation process is overcome, thereby improving the using experience of the user.

In order to solve the above technical problem, the present disclosure adopts the technical solution below:

A protector sticking assist device for electronic equipment, including a protector sticking assist device main body, an electronic equipment containing slot is formed at a position where the protector sticking assist device main body corresponds to the electronic equipment, where a tempered glass screen protector containing slot is formed in a slot bottom of the electronic equipment containing slot, an interval top resisting portion is disposed between an inner side of a slot wall of the electronic equipment containing slot and a top of a slot wall of the tempered glass screen protector containing slot, and a screen protector traction paste threading slot is formed in a slot wall of a lower end of the electronic equipment containing slot; and when the electronic equipment is contained in the electronic equipment containing slot, the electronic equipment resists to the interval top resisting portion, so that a certain distance is spaced between the electronic equipment and the tempered glass screen protector containing slot, and the screen protector traction paste passes through the screen protector traction paste threading slot so as to tear and remove the screen protector at the back of the tempered glass screen protector main body.

As a preferred solution of the protector sticking assist device for the electronic equipment, the interval top resisting portion is a plurality of resisting convex columns disposed between the inner side of the slot wall of the electronic equipment containing slot and the top of the slot wall of the tempered glass screen protector containing slot.

As a preferred solution of the protector sticking assist device for the electronic equipment, a traction paste containing slot is formed in a slot wall of an upper end of the tempered glass screen protector containing slot, the traction paste containing slot communicates with the tempered glass screen protector containing slot, a traction paste guide slot is formed in a slot bottom of the screen protector traction paste threading slot, and the traction paste guide slot communicates with the tempered glass screen protector containing slot; after the screen protector traction paste is adhered to the screen protector at the back of the tempered glass screen protector main body and contained in the traction paste containing slot, the screen protector traction paste drives the screen protector at the back of the tempered glass screen protector main body to move from the traction paste containing slot to the traction paste guide slot, and the screen protector at the back of the tempered glass screen protector is pulled out of the screen protector traction paste threading slot; and the traction paste guide slot is configured to guide the movement of the screen protector traction paste.

As a preferred solution of the protector sticking assist device for the electronic equipment, a traction paste containing slot is formed in a slot wall of an upper end of the tempered glass screen protector containing slot, and the traction paste containing slot communicates with the tempered glass screen protector containing slot; and after the screen protector traction paste is adhered to the screen protector at the back of the tempered glass screen protector main body and contained in the traction paste containing slot, the screen protector traction paste extends to the screen protector traction paste threading slot from the traction paste containing slot, and the screen protector traction paste is adhered and drives the screen protector at the back of the tempered glass screen protector main body to be pulled out of the screen protector traction paste threading slot.

As a preferred solution of the protector sticking assist device for the electronic equipment, the protector sticking assist device main body is provided with an electronic equipment fixed portion at a position corresponding to the screen protector traction paste threading slot, and the electronic equipment fixed portion spans the screen protector traction paste threading slot.

As a preferred solution of the protector sticking assist device for the electronic equipment, the protector sticking assist device main body is externally extended with a handheld portion, and a hollow portion is formed between the handheld portion and the screen protector assist device main body for easy handhold.

As a preferred solution of the protector sticking assist device for the electronic equipment, a tempered glass screen protector fixed paste threading slot is formed in the slot bottom of the tempered glass screen protector containing slot, two sides of the tempered glass screen protector fixed paste are adhered to the back of the protector sticking assist device main body, a middle of the tempered glass screen protector fixed paste is adhered to the screen protector at the front of the tempered glass screen protector main body after passing through the tempered glass screen protector fixed paste, and then the tempered glass screen protector main body is fixed at the slot bottom of the tempered glass screen protector containing slot.

As a preferred solution of the protector sticking assist device for the electronic equipment, electronic equipment pick-and-place slots are formed in one side or the two sides of the electronic equipment containing slot.

The present disclosure has the following beneficial effects:

In the present disclosure, the protector sticking assist device for the electronic equipment includes a protector sticking assist device main body, the electronic equipment containing slot is formed in the protector sticking assist device main body, the tempered glass screen protector containing slot is formed in the slot bottom of the electronic equipment containing slot, where the interval top resisting portion is disposed between the inner side of the slot wall of the electronic equipment containing slot and the top of the slot wall of the tempered glass screen protector containing slot, and the screen protector traction paste threading slot is formed in the slot wall of the lower end of the electronic equipment containing slot; and when the electronic equipment is contained in the electronic equipment containing slot, the electronic equipment resists to the interval top resisting portion, so that a certain distance is spaced between the electronic equipment and the tempered glass screen protector containing slot, and the electronic equipment screen protector traction paste passes through the screen protector traction paste threading slot so as to tear the screen protector at the back of the tempered glass screen protector. After adopting the above solution, the tempered glass screen protector with the screen protector is placed into the tempered glass screen protector containing slot first during a using process, the electronic equipment is placed into the electronic equipment containing slot, the user pulls out the screen protector traction paste from the position of the screen protector traction paste threading slot, and then the screen protector at the back of the tempered glass screen protector is torn. Before sticking the protector, the screen protector at the back of the tempered glass screen protector main body does not need to be torn manually, and the defect that the sticking surface of the tempered glass screen is easy to absorb dust in the air during the manual operation process or taint with fingerprint of the user during the operation process is overcome, thereby improving the using experience of the user.

### BRIEF DESCRIPTION OF THE DRAWINGS

To better clarify the technical solution in the embodiments of the present disclosure, the drawings required to illustrate the embodiments will be simply described below. It is apparent that the drawings described below merely illustrate some embodiments of the present disclosure. Those ordinarily skilled in the art can obtain other drawings without creative labor on the basis of those drawings, and these drawings fall into the protection scope of the present disclosure.

FIG. 1 is a structural schematic diagram of a protector sticking assist device for electronic equipment in an angle of Embodiment I of the present disclosure;

FIG. 2 is a structural schematic diagram of a protector sticking assist device for electronic equipment in another angle of FIG. 1;

FIG. 3 is an exploded schematic diagram of a protector sticking assist device for electronic equipment in a using state of FIG. 1;

FIG. 4 is a structural schematic diagram of a protector sticking assist device for electronic equipment in an angle of Embodiment II of the present disclosure;

FIG. 5 is a structural schematic diagram of a protector sticking assist device for electronic equipment in another angle of FIG. 4; and

FIG. 6 is a section view of a protector sticking assist device for electronic equipment of FIG. 4.

### DETAILED DESCRIPTION OF THE EMBODIMENTS

The technical solutions in the embodiments of the present disclosure are clearly and completely elaborated below. It is apparent that the described embodiments are only a part of the embodiments of the present disclosure but not all. Based on the embodiments of the present disclosure, all the other embodiments obtained by those of ordinary skill in the art on the premise of not contributing creative effort should belong to the protection scope of the present disclosure.

Therefore, the detail description for the embodiments of the present disclosure provided in the drawings below is not intended to limit the protection scope of the present disclosure, and merely shows the selected embodiments of the present disclosure. It is noted that various features in embodiments of the present disclosure may be combined with each other without conflict, and the combined embodiments are still in the protection scope of the present disclosure.

In the description of the present disclosure, it is also noted that, unless specific regulation and limitation otherwise, terms “set”, “install”, “join” and “connect” should be generally understood, for example, may a fixed connection, or a detachable connection, or an integrated connection, may a mechanical connection or an electric connection, may a direct connection or an indirect connection through an intermediation, and may an internal connection of two elements. Those of ordinary skill in the art may understand the specific meaning of the terms in the present disclosure according to specific conditions.

With the improvement of living standards, people also have higher and higher using frequency for portable electronic equipment, such as mobile phones, tablet computers, etc. For protecting the screen of the electronic equipment, users will usually paste a layer of tempered glass screen protector on a surface of a display screen so as to enhance screen protection. Nowadays, the screen protector for the electronic equipment is the tempered glass screen protector. Usually, in order to protect the tempered glass screen protector reliably when leaving the factory and prevent the damage on the tempered glass screen protector during a transportation process or a machining process, two sides of screen protectors are arranged inside and outside the tempered glass screen protector for protecting the tempered glass screen protector. Therefore, the tempered glass screen protector sold on the market usually includes a tempered glass screen protector main body, and the front and the rear of the tempered glass screen protector will be all pasted with a release layer screen protector. During protector sticking, the screen protector at the back is torn first, and then the tempered glass screen protector main body is pasted on the electronic equipment; and after air between the tempered glass screen protector main body and a screen is squeezed out, the screen protector at the front of the tempered glass screen protector main body is torn, namely, the protector sticking work is finished.

However, the screen protector at the back of the tempered glass screen protector main body needs to be torn manually before sticking the protector, and then the tempered glass screen protector main body is placed in the protector sticking assist device for the electronic equipment for sticking the protector. During a manual operation process, a sticking surface of the tempered glass screen protector is easy to absorb dust in the air or taint with fingerprint of a user during an operation process, so that the tempered glass screen protector main body cannot be used normally due to being tainted with flaws, thereby affecting the using experience of the user.

### Embodiment I

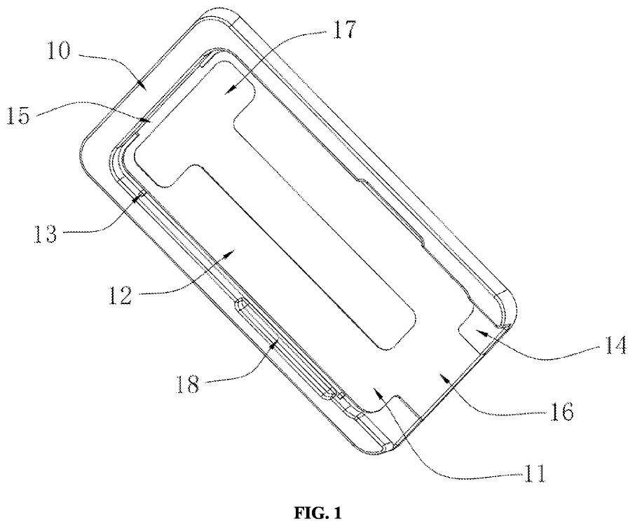

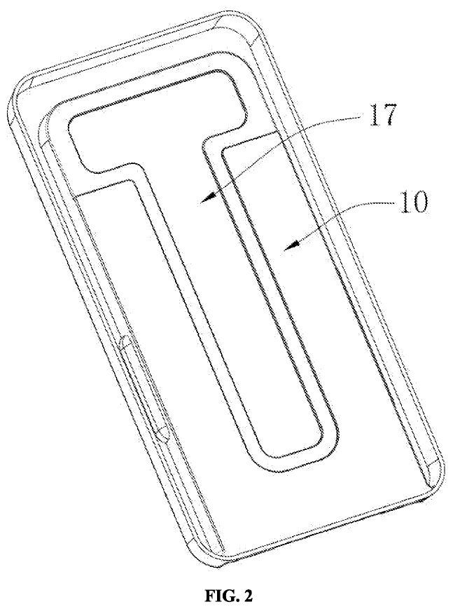

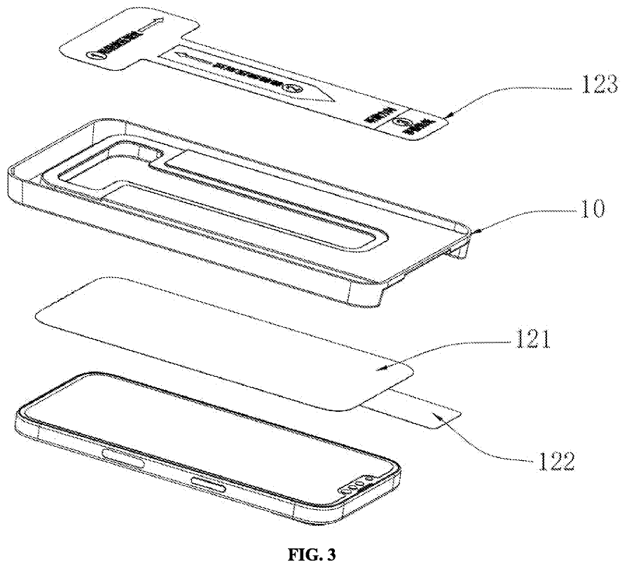

In the embodiment I of the present disclosure, as shown in FIG. 1, FIG. 2 and FIG. 3, an embodiment of the present disclosure provides a protector sticking assist device for electronic equipment, which is mainly applied for protector sticking of small electronic equipment, such as mobile phones and the like, and the protector sticking assist device includes a protector sticking assist device main body 10, an electronic equipment containing slot 11 is formed at a position where the protector sticking assist device main body 10 corresponds to the electronic equipment, and a front face of the electronic equipment is contained in the electronic equipment containing slot 11;

a tempered glass screen protector containing slot 12 is formed in a slot bottom of the electronic equipment containing slot 11, a tempered glass screen protector 121 can be contained in the tempered glass screen protector containing slot 12, an interval top resisting portion 13 is disposed between an inner side of a slot wall of the electronic equipment containing slot 11 and a top of a slot wall of the tempered glass screen protector containing slot 12, a screen protector traction paste threading slot 14 is formed in a slot wall of a lower end of the electronic equipment containing slot 11; and a screen protector traction paste 122 extends out of the screen protector traction paste threading slot 14;

when the electronic equipment is contained in the electronic equipment containing slot 11, the electronic equipment resists to the interval top resisting portion 13, so that a certain distance is spaced between the electronic equipment and the tempered glass screen protector containing slot 12; and after the screen protector traction paste 122 passes through the screen protector traction paste threading slot 14 from inside to outside to tear the screen protector at the back of the tempered glass screen protector 121 main body, the screen protector at the back of the tempered glass screen protector 121 main body is moved out from the screen protector traction paste threading slot 14.

In the present disclosure, after adopting the above solution, the tempered glass screen protector 121 with the screen protector is placed into the tempered glass screen protector containing slot 12 first during the using process, the electronic equipment is placed into the electronic equipment containing slot 11, the user pulls out the screen protector traction paste 122 from the position of the screen protector traction paste threading slot 14, and then the screen protector at the back of the tempered glass screen protector 121 is torn. Before sticking the protector, the screen protector at the back of the tempered glass screen protector 121 main body does not need to be torn manually, and the defect that the sticking surface of the tempered glass screen protector 121 is easy to absorb dust in the air during the manual operation process or taint with fingerprint of the user during the operation process is overcome, thereby improving the using experience of the user.

In the present disclosure, preferably, the interval top resisting portion 13 is a plurality of resisting convex columns 13 disposed between an inner side of a slot wall of the electronic equipment containing slot 11 and a top of a slot wall of the tempered glass screen protector containing slot 12, and not limited to this embodiment. The interval top resisting portion 13 may also be an annular resisting protrusion 13 disposed between the inner side of the slot wall of the electronic equipment containing slot 11 and the top of the slot wall of the tempered glass screen protector containing slot 12, or a resisting protrusion 13 detachably installed between the inner side of the slot wall of the electronic equipment containing slot 11 and the top of the slot wall of the tempered glass screen protector containing slot 12; and as long as a certain distance is spaced between the electronic equipment and the tempered glass screen protector containing slot 12, a limitation is not made in the present disclosure.

In order to adhere and pull out the screen protector traction paste 122 conveniently, a traction paste containing slot 15 is formed in the slot wall of the upper end of the tempered glass screen protector containing slot 12, a traction paste guide slot 16 is formed in a slot bottom of the screen protector traction paste threading slot 14, and the traction paste guide slot 16 communicates with the tempered glass screen protector containing slot 12; and

after the screen protector traction paste 122 is adhered to the screen protector at the back of the tempered glass screen protector 121 main body and contained in the traction paste containing slot 15, the screen protector traction paste 122 drives the screen protector at the back of the tempered glass screen protector 121 main body to move from the traction paste containing slot 15 to the traction paste guide slot 16, the screen protector at the back of the tempered glass screen protector 121 is pulled out of the screen protector traction paste threading slot 14, the traction paste guide slot 16 is configured to guide the movement of the screen protector traction paste 122 and remove the the screen protector traction paste 122, and finally the screen protector at the back of the tempered glass screen protector 121 main body is torn and moves out of the screen protector traction paste threading slot 14; and the screen protector traction paste 122 moves out of the traction paste guide slot 16.

In order to tear the screen protector at the back of the tempered glass screen protector 121 main body from the screen protector traction paste 122 and fix the tempered glass screen protector 121 main body, a tempered glass screen protector fixed paste threading slot 17 is formed in a slot bottom of the tempered glass screen protector containing slot 12, two sides of the tempered glass screen protector fixed paste 123 are adhered to the back of the protector sticking assist device main body 10, a middle of the tempered glass screen protector fixed paste 123 is adhered to the screen protector at the front of the tempered glass screen protector 121 main body after passing through the tempered glass screen protector fixed paste threading slot 17, and then the tempered glass screen protector 121 main body is fixed at the slot bottom of the tempered glass screen protector containing slot 12.

In the present disclosure, after the screen protector at the back of the tempered glass screen protector 121 main body is torn through the screen protector traction paste 122, the tempered glass screen protector fixed paste 123 is also torn, and at this time, the back of the tempered glass screen protector 121 main body is closed to the front of the electronic equipment and adhered to the front of the electronic equipment. Without a manual operation and this process occurs in a sealed space, the dust in the air will not be absorbed and the fingerprint of the user will not be tainted during the protector sticking process; and then after the electronic equipment is taken out, the screen protector at the front of the tempered glass screen protector 121 main body is manually torn, and the whole protector sticking process is finished.

In order to pick and place the electronic equipment conveniently, electronic equipment pick-and-place slots 18 are formed in two sides of the electronic equipment containing slot 11, and fingers of the user are convenient to stretch into the electronic equipment pick-and-place slots 18, so as to pick and place the electronic equipment conveniently.

### Embodiment II

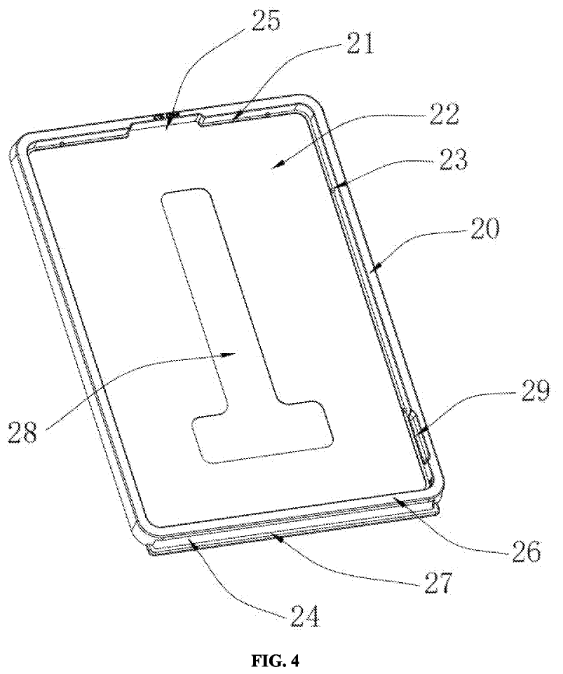

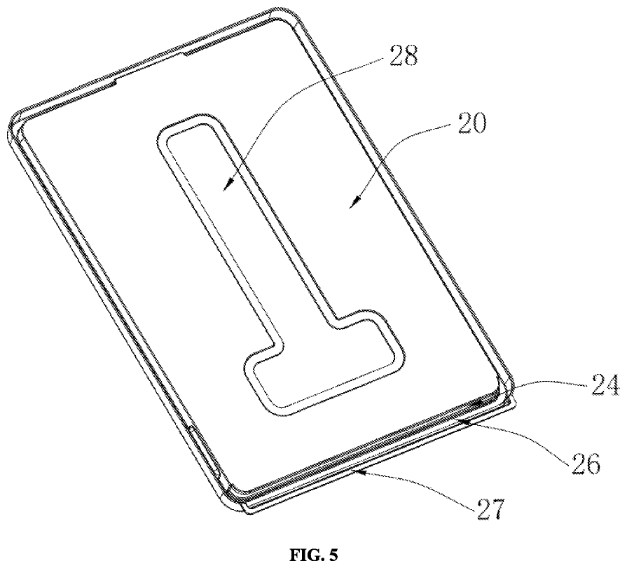

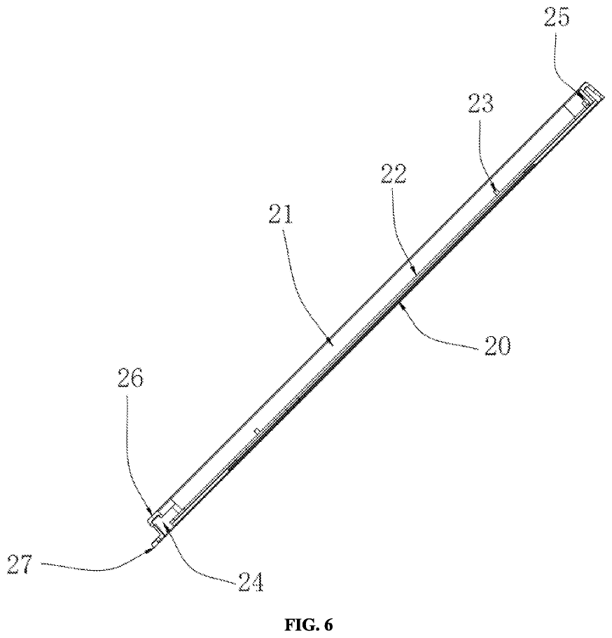

In the embodiment II of the present disclosure, as shown in FIG. 4, FIG. 5 and FIG. 6, this embodiment provides another protector sticking assist device for electronic equipment, which is mainly applied in large electronic equipment, such as tablet computers; and the protector sticking assist device includes a protector sticking assist device main body 20, an electronic equipment containing slot 21 is formed at a position where the protector sticking assist device main body 20 corresponds to the electronic equipment, and a front face of the electronic equipment is contained in an electronic equipment containing slot 21;

a tempered glass screen protector containing slot 22 is formed in a slot bottom of the electronic equipment containing slot 21, the tempered glass screen protector can be contained in the tempered glass screen protector containing slot 22, an interval top resisting portion 23 is disposed between an inner side of a slot wall of the electronic equipment containing slot 21 and a top of a slot wall of the tempered glass screen protector containing slot 22, a screen protector traction paste threading slot 24 is formed in a slot wall of a lower end of the electronic equipment containing slot 21; and the screen protector traction paste extends out of the screen protector traction paste threading slot 24;

when the electronic equipment is contained in the electronic equipment containing slot 21, the electronic equipment resists to the interval top resisting portion 23, so that a certain distance is spaced between the electronic equipment and the tempered glass screen protector containing slot 22; and after the screen protector traction paste passes through the screen protector traction paste threading slot 24 from inside to outside to tear the screen protector at the back of the tempered glass screen protector main body, the screen protector at the back of the tempered glass screen protector main body is moved out of the screen protector traction paste threading slot 24.

In the present disclosure, preferably, the interval top resisting portion 23 is a plurality of resisting convex columns 23 disposed between an inner side of a slot wall of the electronic equipment containing slot 21 and a top of a slot wall of the tempered glass screen protector containing slot 22, and not limited to this embodiment. The interval top resisting portion 23 may also be an annular resisting protrusion 23 disposed between the inner side of the slot wall of the electronic equipment containing slot 21 and the top of the slot wall of the tempered glass screen protector containing slot 22, or a resisting protrusion 23 detachably installed between the inner side of the slot wall of the electronic equipment containing slot 21 and the top of the slot wall of the tempered glass screen protector containing slot 22; and as long as a certain distance is spaced between the electronic equipment and the tempered glass screen protector containing slot 22, a limitation is not made in the present disclosure.

The difference between the embodiment II and the embodiment I is as follows: the embodiment I is suitable for small electronic equipment, such as mobile phones and other electronic equipment, in order to ensure that the user pulls out the screen protector traction paste stably, conveniently and quickly during a process of tearing the screen protector, the traction paste containing slot 15 is formed in the slot wall of the upper end of the tempered glass screen protector containing slot 12, the traction paste containing slot 15 communicates with the tempered glass screen protector containing slot 12, the traction paste guide slot 16 is formed in the slot wall of the bottom end of the screen protector traction paste threading slot 14, and the traction paste guide slot 16 communicates with the tempered glass screen protector containing slot 12; and however the embodiment II is suitable for large electronic equipment, such as tablet computers, since the movement of the screen protector traction paste is more stable during a protector tearing process of the equipment, the traction paste guide slot 16 is not disposed in the embodiment II.

In order to stick and pull out the screen protector traction paste conveniently, the traction paste containing slot 25 is formed in the slot wall of the upper end of the tempered glass screen protector containing slot 22, and the traction paste containing slot 25 communicates with the tempered glass screen protector containing slot 22; during the using process, after the screen protector traction paste is adhered to the screen protector at the back of the tempered glass screen protector main body and contained in the traction paste containing slot 25, the screen protector traction paste extends to the screen protector traction paste threading slot 24 from the traction paste containing slot 25, the screen protector traction paste is adhered and drives the screen protector at the back of the tempered glass screen protector main body to be pulled out of the screen protector traction paste threading slot 24, and finally the screen protector traction paste and the screen protector at the back of the tempered glass screen protector main body are pulled out of the screen protector traction paste threading slot 24.

In order to fix the electronic equipment, the protector sticking assist device main body 20 is provided with an electronic equipment fixed portion 26 at a position corresponding to the screen protector traction paste threading slot 24, and the electronic equipment fixed portion 26 spans the screen protector traction paste threading slot 24; and during the using process, the bottom of the electronic equipment resists to the electronic equipment fixed portion 26, so as to prevent from taking the electronic equipment out of the protector sticking assist device main body 20 during a protector tearing process.

Since the protector sticking assist device for the electronic equipment in the embodiment II is greater in volume and inconvenient to operate, for convenient operation, the protector sticking assist device main body 20 is externally extended with a handheld portion 27, and a hollow portion is formed between the handheld portion 27 and the screen protector assist device main body 20 for easy handhold, and then the protector sticking assist device for the electronic equipment is convenient to operate.

In order to tear the screen protector at the back of the tempered glass screen protector main body from the screen protector traction paste and fix the tempered glass screen protector main body, a tempered glass screen protector fixed paste threading slot 28 is formed in a slot bottom of the tempered glass screen protector containing slot 22, two sides of the tempered glass screen protector fixed paste are adhered to the back of the protector sticking assist device main body 20, a middle of the tempered glass screen protector fixed paste is adhered to the screen protector at the front of the tempered glass screen protector main body after passing through the tempered glass screen protector fixed paste threading slot 28, and then the tempered glass screen protector main body is fixed at the slot bottom of the tempered glass screen protector containing slot 22.

In the present disclosure, after the screen protector at the back of the tempered glass screen protector main body is torn through the screen protector traction paste, the tempered glass screen protector fixed paste is also torn, and at this time, the back of the tempered glass screen protector main body is closed to the front of the electronic equipment and adhered to the front of the electronic equipment. Without a manual operation and this process occurs in a sealed space, the dust in the air will not be absorbed and the fingerprint of the user will not be tainted during the protector sticking process; and then the electronic equipment is taken out, the screen protector at the front of the tempered glass screen protector main body is manually torn, and the whole protector sticking process is finished.

In order to pick and place the electronic equipment conveniently, electronic equipment pick-and-place slots 29 are formed in one side of the electronic equipment containing slot 21, and fingers of the user are convenient to stretch into the electronic equipment pick-and-place slots 29, so as to pick and place the electronic equipment conveniently.

The present disclosure is described in detail above in combination with drawings, but the present disclosure is not limited to the described implementation modes. Those skilled in the art may make various changes, modifications, replacements and deformations to these implementation modes without deviating from the principle and spirit of the present disclosure, and these changes, modifications, replacements and deformations fall into the protection scope of the present disclosure.

What is claimed is:

1. A protector sticking assist device for electronic equipment, comprising a protector sticking assist device main body, and an electronic equipment containing slot is formed at a position where the protector sticking assist device main body corresponds to the electronic equipment;
wherein a tempered glass screen protector containing slot is formed in a slot bottom of the electronic equipment containing slot, an interval top resisting portion is disposed between an inner side of a slot wall of the electronic equipment containing slot and a top of a slot wall of the tempered glass screen protector containing slot, and a screen protector traction paste threading slot is formed in a slot wall of a lower end of the electronic equipment containing slot; and
when the electronic equipment is contained in the electronic equipment containing slot, the electronic equipment resists to the interval top resisting portion, so that a certain distance is spaced between the electronic equipment and the tempered glass screen protector containing slot, and a screen protector traction paste passes through the screen protector traction paste threading slot so as to tear and remove screen protector at a back of a tempered glass screen protector main body.

2. The protector sticking assist device for the electronic equipment according to claim 1, wherein the interval top resisting portion is a plurality of resisting convex columns disposed between the inner side of the slot wall of the electronic equipment containing slot and the top of the slot wall of the tempered glass screen protector containing slot.

3. The protector sticking assist device for the electronic equipment according to claim 1, wherein a traction paste containing slot is formed in a slot wall of an upper end of the tempered glass screen protector containing slot, the traction paste containing slot communicates with the tempered glass screen protector containing slot, a traction paste guide slot is formed in a slot wall of a bottom end of the screen protector traction paste threading slot, and the traction paste guide slot communicates with the tempered glass screen protector containing slot; and
after the screen protector traction paste is adhered to the screen protector at the back of the tempered glass screen protector main body and contained in the traction paste containing slot, the screen protector traction paste drives the screen protector at the back of the tempered glass screen protector main body to move from the traction paste containing slot to the traction paste guide slot, the screen protector at the back of the tempered glass screen protector is pulled out of the screen protector traction paste threading slot, and the traction paste guide slot is configured to guide the movement of the screen protector traction paste and remove the screen protector traction paste.

4. The protector sticking assist device for the electronic equipment according to claim 1, wherein a traction paste containing slot is formed in the slot wall of the upper end of the tempered glass screen protector containing slot, and the traction paste containing slot communicates with the tempered glass screen protector containing slot; and
after the screen protector traction paste is adhered to the screen protector at the back of the tempered glass screen protector main body and contained in the traction paste containing slot, the screen protector traction paste extends to the screen protector traction paste threading slot from the traction paste containing slot, the screen protector traction paste is adhered and drives the screen protector at the back of the tempered glass screen protector main body to be pulled out of the screen protector traction paste threading slot.

5. The protector sticking assist device for the electronic equipment according to claim 4, wherein the protector sticking assist device main body is provided with an electronic equipment fixed portion at a position corresponding to the screen protector traction paste threading slot, and the electronic equipment fixed portion spans the screen protector traction paste threading slot.

6. The protector sticking assist device for the electronic equipment according to claim 5, wherein the protector sticking assist device main body is externally extended with a handheld portion, and a hollow portion is formed between the handheld portion and the screen protector assist device main body for easy handhold.

7. The protector sticking assist device for the electronic equipment according to claim 1, wherein a tempered glass screen protector fixed paste threading slot is formed in the slot bottom of the tempered glass screen protector containing slot, two sides of the tempered glass screen protector fixed paste are adhered to the back of the protector sticking assist device main body, a middle of the tempered glass screen protector fixed paste is adhered to the screen protector at the front of the tempered glass screen protector main body after passing through the tempered glass screen protector fixed paste threading slot, and then the tempered glass screen protector main body is fixed at the slot bottom of the tempered glass screen protector containing slot.

8. The protector sticking assist device for the electronic equipment according to claim 1, wherein electronic equipment pick-and-place slots are formed in one side or two sides of the electronic equipment containing slot.
